(19) United States
(12) Patent Application Publication
(10) Pub. No.: US 2025/0238002 A1
(43) Pub. Date: Jul. 24, 2025

(54) CONTROL SYSTEM, CONTROL METHOD, AND RECORDING MEDIUM

(71) Applicants: NEC CORPORATION, Tokyo (JP); NATIONAL INSTITUTE OF ADVANCED INDUSTRIAL SCIENCE AND TECHNOLOGY, Tokyo (JP)

(72) Inventors: Shumpei KUBOSAWA, Tokyo (JP); Makoto SAKAHARA, Tokyo (JP); Takashi ONISHI, Tokyo (JP)

(73) Assignees: NEC CORPORATION, Tokyo (JP); NATIONAL INSTITUTE OF ADVANCED INDUSTRIAL SCIENCE AND TECHNOLOGY, Tokyo (JP)

(21) Appl. No.: 18/703,627

(22) PCT Filed: Oct. 17, 2022
(86) PCT No.: PCT/JP2022/038567

§ 371 Date: Apr. 22, 2024

(30) Foreign Application Priority Data
Oct. 25, 2021 (JP) 2021-173888

(51) Int. Cl. G05B 13/02

(52) U.S. Cl. CPC G05B 13/0265

(57) ABSTRACT

A control system includes: a switching unit that switches, for sections of a control subject, between normal condition control and non-normal condition control of the sections, based on a state of at least one section among the sections of the control subject; and a control unit that performs control of the sections of the control subject according to a switching of control by the switching unit.

### TECHNICAL FIELD

The present invention relates to a control system, a control method, and a recording medium.

### BACKGROUND ART

In a control, a target state is sometimes set for a state of a control subject, and a state of the control subject is controlled so as to approach the target state.

For example, in the vehicle automatic control system described in Patent Document 1, a target schedule creation device creates and updates a target schedule, and an operation management system controls the operation of trains in a train operation network according to the target schedule.

### PRIOR ART DOCUMENTS

### Patent Documents

Patent Document 1: PCT International Publication No. WO2019/078025

### SUMMARY OF THE INVENTION

### Problems to be Solved by the Invention

When an abnormality occurs in a control subject, it is conceivable to switch control of the control subject. In this case, it is considered preferable that a difference between the state of the control subject after switching control and the state of the control subject under normal conditions is as small as possible.

An example object of the present disclosure is to provide a control system, a control method, and a recording medium that are capable of solving the above problem.

### Means for Solving the Problem

According to a first example aspect of the present disclosure, a control system includes: a switching means that switches, for sections of a control subject, between normal condition control and non-normal condition control of the sections, based on a state of at least one section among the sections of the control subject; and a control means that performs control of the sections of the control subject according to a switching of control by the switching means.

According to a second example aspect of the present disclosure, a control method executed by a computer, includes: switching, for sections of a control subject, between normal condition control and non-normal condition control of the sections, based on a state of at least one section among the sections of the control subject; and performing control of the sections of the control subject according to a switching of the control.

According to a third example aspect of the present disclosure, a recording medium stores a program that causes a computer to execute: switching, for sections of a control subject, between normal condition control and non-normal condition control of the sections, based on a state of at least one section among the sections of the control subject; and performing control of the sections of the control subject according to a switching of the control.

### Effect of Invention

According to the present disclosure, it is expected that a difference between the state of a control subject after switching control in response to the occurrence of an abnormality in the control subject, and the state of the control subject under normal conditions will be relatively small.

### BRIEF DESCRIPTION OF THE DRAWINGS

FIG. 1 is a diagram showing an example of a configuration of a control system according to an example embodiment.

FIG. 2 is a diagram showing an example of an assignment of control units to sections of a control subject under normal conditions of the control subject according to an example embodiment.

FIG. 3 is a diagram showing an example of an assignment of control units to sections of a control subject at the time an abnormality occurs in the control subject according to an example embodiment.

FIG. 4 is a diagram showing an example of an assignment of control units to sections of a control subject when an abnormality has been resolved in the control subject according to an example embodiment.

FIG. 5 is a diagram showing an example of the processing procedure performed by a control system according to an example embodiment.

FIG. 6 is a diagram showing a second configuration example of a control system according to an example embodiment.

FIG. 7 is a diagram showing a third configuration example of a control system according to an example embodiment.

FIG. 8 is a diagram showing a fourth configuration example of a control system according to an example embodiment.

FIG. 9 is a diagram showing a fifth configuration example of a control system according to an example embodiment.

FIG. 10 is a diagram showing a sixth configuration example of a control system according to an example embodiment.

FIG. 11 is a diagram showing a seventh configuration example of a control system according to an example embodiment.

FIG. 12 is a diagram showing an example of the processing procedure of a control method according to an example embodiment.

FIG. 13 is a schematic block diagram showing a configuration of a computer according to at least one example embodiment.

### EXAMPLE EMBODIMENT

Hereunder, an example embodiment of the present disclosure will be described.

However, the following example embodiment does not limit the invention according to the claims. Furthermore, not all combinations of features described in the example embodiment are essential to the solution means of the invention.

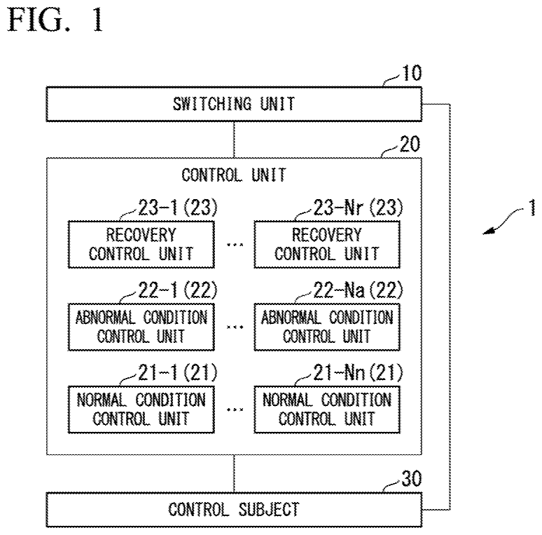

FIG. 1 is a diagram showing an example of a configuration of a control system according to an example embodiment. In the configuration shown in FIG. 1, the control system 1 includes a switching unit 10 and a control unit 20. The control unit 20 includes a plurality of normal condition control units 21, one or more abnormal condition control units 22, and one or more recovery control units 23. Furthermore, a control subject 30 is shown in FIG. 1.

The control system 1 is a system that performs control of the control subject 30.

The control subject 30 operates according to control by the control system 1. In the control subject 30, a target state under normal conditions is set (that is to say, dynamically set) for each time. The control subject 30 is divided into a plurality of sections, and the control subject 30 can be controlled by control of each section. Further, the control subject 30 can be various subjects in which local abnormalities can occur, and is not limited to being a specific subject.

The control subject 30 may be configured as a single device, or may be configured as a system including a plurality of devices. Alternatively, the control subject 30 may be configured as a portion of a device or system.

Here, the occurrence of an abnormality in the control subject 30 refers to a state where at least one section among the sections of the control subject 30 is in a state that is different to the state that has been set in advance as a normal state. The abnormality in the control subject 30 may be an abnormality that occurs due to an internal factor of the control subject 30, or may be an abnormality that occurs due to an external factor of the control subject 30.

Under normal conditions of the control subject 30, the state of the entire control subject 30 is in a state that has been set in advance as the normal state. The state of the control subject 30 being in the normal state may also refer to an error between the state of the control subject 30 and the normal state being within a predetermined range. The state that has been set in advance as the normal state may also be a dynamic state (that is to say, a state that changes as time elapses). Therefore, the state under normal conditions of the control subject 30 may also be a dynamic state.

When the state of the control subject 30 is different from the normal state, the state of the control subject 30 is also referred to as a non-normal state. The state of the control subject 30 being in a non-normal state is also referred to as being under non-normal conditions.

The control subject 30 may be configured as a portion of the control system 1, or may be configured outside the control system 1. Alternatively, the control system 1 may be configured as a portion of the control subject 30, such as when a transportation system is configured to include a control system. Examples of the control subject 30 include, but are not limited to, transportation systems such as a railway, plants such as a chemical plant, and traffic control systems. In the following, a case where the control subject 30 is a railway will be described as an example.

The control unit 20 performs control of the control subject 30 by performing control of each section of the control subject 30, which has been divided into a plurality of sections.

The control unit 20 corresponds to an example of a control means.

The normal condition control units 21 perform normal condition control with respect to the sections of the control subject 30. The normal condition control referred to here is control of the sections of the control subject 30 such that the state of the control subject 30 becomes the state that has been set in advance as the normal state of the control subject 30.

For example, when the control subject 30 is a railway, the normal condition control units 21 perform control of the sections of the control subject 30 such that the trains of the control subject 30 travel according to a normal operation schedule.

Alternatively, when the control subject is a traffic control system, the normal condition control units 21 control the respective aircraft such that the aircraft, which correspond to the sections of the control subject 30, fly according to a flight plan.

Alternatively, when the control subject 30 is a chemical plant, the normal condition control units 21 may control the sections of the control subject 30 such that a measurement value of a sensor provided in the control subject 30 becomes a value that has been set in advance as a normal value.

The normal condition control units 21 may perform normal condition control with respect to the sections of the control subject 30 based on state information of the entire control subject 30. Alternatively, the normal condition control units 21 may perform normal condition control with respect to the sections of the control subject 30 based on state information of the section of the control subject 30 that the normal condition control unit 21 itself controls.

The control unit 20 includes the same number of normal condition control units 21 as sections of the control subject 30, and the sections of the control subject 30 and the normal condition control units 21 that control the sections may be associated one-to-one. When distinguishing between the individual normal condition control units 21, they are denoted as a normal condition control unit 21-1, a normal condition control unit 21-2, . . . , and a normal condition control unit 21-Nn (where Nn is a positive integer representing the number of normal condition control units 21).

The abnormal condition control units 22 perform abnormal condition control with respect to the sections of the control subject 30. The abnormal condition control referred to here is control of the sections of the control subject 30 such that the control subject 30 continues to operate in response to an abnormality that has occurred in a portion of the control subject 30.

For example, when the control subject 30 is a railway, and an unpassable sector occurs on a trajectory due to the occurrence of an abnormality, if trains become concentrated and stop before the unpassable sector under a normal condition control, it is conceivable that the train operation may be unable to be provided to passengers.

Furthermore, when the control subject 30 is a chemical plant, and the state of the chemical plant has greatly deviated from the normal state due to the occurrence of an abnormality, it is conceivable that the chemical plant may be stopped by a protection logic. It is conceivable that the stoppage of a chemical plant will significantly reduce production volume, and require a long time for recovery.

In contrast, if the operation of the control subject 30 can be maintained by the control of the abnormal condition control units 22, the functions of the control subject 30 can be maintained even if the functions are reduced. For example, it is possible to continue providing transportation services to customers, or manufacturing of products. Furthermore, if the operation of the control subject 30 can be maintained by the control of the abnormal condition control units 22, it is expected that recovery of the normal state will be performed relatively quickly when the abnormality in the control subject 30 is resolved.

At the time an abnormality occurs in the control subject 30 (when an abnormality has occurred in the control subject 30), the abnormal condition control units 22 perform abnormal condition control with respect to the sections among the sections of the control subject 30 that have been set by the switching unit 10 as sections near an abnormality occurrence location.

The abnormal condition control units 22 control the sections of the control subject 30 such that, in addition to preventing the entire control subject 30 from falling into an inoperable state, the state of the entire control subject 30 approaches the state that has been set as the target state of the control subject 30 under normal conditions. The state that has been set as the target state of the control subject 30 under normal conditions is also referred to as a target normal state.

For example, when the control subject 30 is a railway, the abnormal condition control units 22 control the sections of the control subject 30 such that, in addition to being able to continue operation of the trains, the operation can be performed as close as possible to the normal operation schedule.

It is expected that, as a result of the operation of the trains being close to the operation under the normal operation schedule, the burden on railway personnel will be relatively light. Furthermore, it is expected that, as a result of the operation of the trains being close to the operation under the normal operation schedule, recovery to the normal state will be performed relatively quickly when the abnormal state is resolved.

The control by the abnormal condition control units 22 that prevents the entire control subject 30 from falling into an inoperable state, and causes the state of the entire control subject 30 to approach the target normal state is performed, for example, by performing learning using an evaluation function that, at the time of the learning of the control by the abnormal condition control unit 22, an evaluation becomes higher when the operation of the control subject 30 is continued, and an evaluation becomes higher when the state of the control subject 30 is close to the target normal state.

The control unit 20 may include the same number of abnormal condition control units 22 as the number of sections of the control subject 30. Alternatively, among the sections of the control subject 30, because only some of the sections need to be controlled at the same time by abnormal condition control, the control unit 20 may include a smaller number of abnormal condition control units 22 than the number of sections of the control subject 30. When distinguishing between the individual abnormal condition control units 22, they are denoted as an abnormal condition control unit 22-1, an abnormal condition control unit 22-2, . . . , and an abnormal condition control unit 22-Na (where Na is a positive integer representing the number of abnormal condition control units 22).

The recovery control units 23 control the section of the control subject 30 such that the state of the control subject 30 recovers to the normal state (the state under normal conditions). Specifically, switching is performed to the recovery control units 23 from the abnormal condition control units 22 when the switching unit 10 determines that the abnormality in the control subject 30 has been resolved. Then, the recovery control units 23 control the sections of the control subject 30 such that the state of the control subject 30 recovers from the state corresponding to the occurrence of an abnormality, to the normal state. When distinguishing between the individual recovery control units 23, they are denoted as a recovery control unit 23-1, a recovery control unit 23-2, . . . , and a recovery control unit 23-Nr (where Nr is a positive integer representing the number of recovery control units 23).

When the state of the control subject 30 recovers to the normal state without the need to switch control from the control by the abnormal condition control units 22, the abnormal condition control units 22 may continue the control of the sections of the control subject 30 when the abnormality in the control subject 30 is resolved. In this case, the control unit 20 does not have to include the recovery control units 23.

The switching unit 10 assigns any one of the normal condition control units 21, the abnormal condition control units 22, and the recovery control units 23 as the control units (sections of the control unit 20) that perform control with respect to the sections of the control subject 30. As a result, the switching unit 10 selects one of normal condition control, abnormal condition control, and recovery control as the control of each section of the control subject 30. The switching unit 10 corresponds to an example of a switching means.

Specifically, the switching unit 10 acquires the state information of the control subject 30, and determines the state of the control subject 30 in real time. When the switching unit 10 determines that the control subject 30 is in the normal state, it assigns normal condition control units 21 to control each portion of the control subject 30, and the normal condition control units 21 perform normal condition control with respect to the sections of the control subject 30.

When the switching unit 10 detects the occurrence of an abnormality in the control subject 30, it specifies an abnormality occurrence location. Then, the switching unit 10 sets, among the sections of the control subject 30, the sections near the abnormality occurrence location. The sections near the abnormality occurrence location may include, among the sections of the control subject 30, a section that includes the abnormality occurrence location. The switching unit 10 switches the control units assigned to the sections set near the abnormality occurrence location, from normal condition control units 21 to abnormal condition control units 22.

In addition to the section that includes the abnormality occurrence location, the switching unit 10 may set, among the sections of the control subject 30, sections having the function of reducing the spread of the effect of the abnormality, as sections near the abnormality occurrence location.

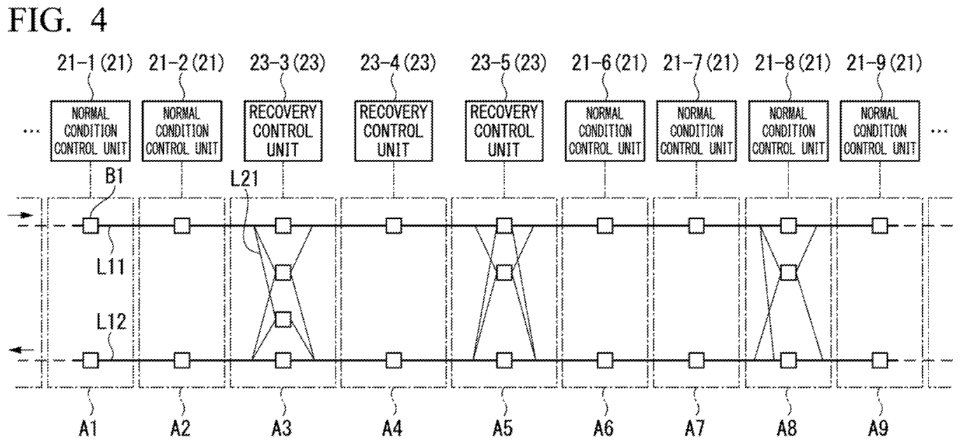

When the control subject 30 is a railway, and the sections of the control subject 30 are sectors of the travel routes of the trains, the sectors in which trains can perform a turn-around operation correspond to an example of sections having the function of reducing the spread of the effect of the abnormality. This point will be discussed later with reference to FIG. 4.

When the switching unit 10 detects that the abnormality in the control subject 30 has been resolved, it switches assignment of the functional units to the sections among the sections of the control subject 30 to which abnormal condition control units 22 have been assigned, from abnormal condition control units 22 to recovery control units 23. As a result, the control with respect to these sections is switched from abnormal condition control to recovery control. However, as described above, the recovery control units 23 are not essential to the control system 1. The switching unit 10 may continue to assign abnormal condition control units 22 to the sections of the control subject 30 after detecting that the abnormality in the control subject 30 has been resolved, until the state of the control subject 30 recovers to the normal state.

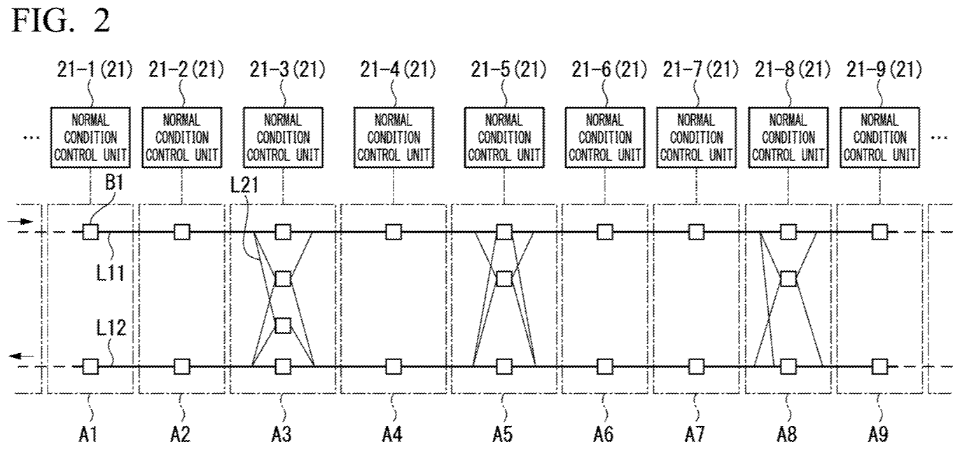

FIG. 2 is a diagram showing an example of an assignment of control units to the sections of the control subject 30 under normal conditions of the control subject 30. FIG. 2 shows an example of a case where the control subject 30 is a railway. The line L11 represents a travel route of a train from the left side to the right side of FIG. 2 on the railway line. The line L12 represents a travel route of a train from the right side to the left side of FIG. 2 on the railway line. A travel route is also referred to as a trajectory.

A square “o” in FIG. 2, which is exemplified by the square B1, represents a station platform. The lines between the line L11 and the line L12, which is exemplified by the line L21, represents a trajectory that connects the trajectory represented by the line L11 and the trajectory represented by the line L12. A train is capable of a turn-around operation due to the trajectories connecting the line L11 and the line L12.

The routes indicated by the line L11 and the line L12 are divided into a plurality of sectors, and FIG. 2 shows sectors A1 to A9. Each sector from sector A1 to A9 includes one station. It is possible for trains to perform a turn-around operation in sectors A3, A5, and A8. Each of the sectors A1 to A9 corresponds to an example of a section of the control subject 30. However, the dividing method of dividing the control subject 30 into a plurality of sections is not limited to a specific method. For example, the sector A6 and the sector A7 may be one section of the control subject 30. That is, a plurality of sectors may be treated as one section of the control subject.

In the example of FIG. 2, the switching unit 10 has assigned normal condition control units 21 to each of the sectors A1 to A9. As a result, the control unit 20 performs control of each of the sectors from sector A1 to A9 according to normal condition control.

When distinguishing between the normal condition control units 21 that have been assigned to sectors A1 to A9 in FIG. 2, the normal condition control unit 21 that has been assigned to sector Ai (where i is an integer such that 1≤i≤9) is denoted as the normal condition control unit 21-i.

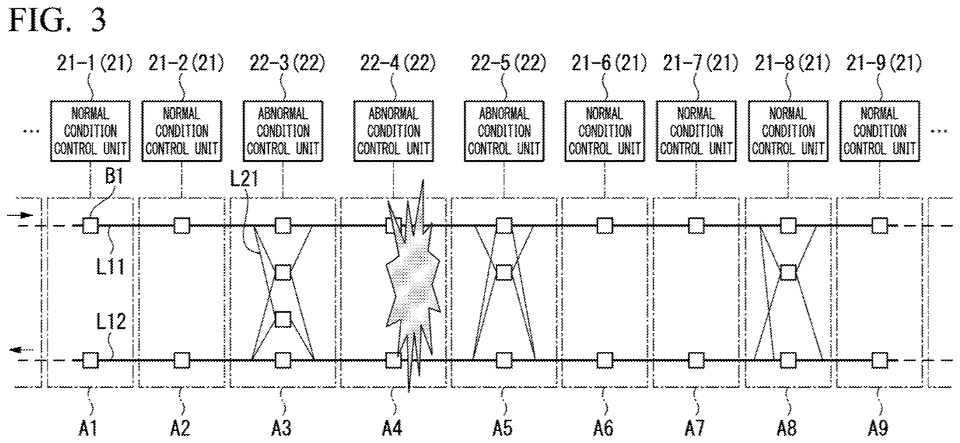

FIG. 3 is a diagram showing an example of an assignment of control units to the sections of the control subject 30 at the time an abnormality occurs in the control subject 30. FIG. 3 shows an example in which an abnormality has occurred in sector A4 of the railway route shown in FIG. 2, causing sector A4 to be an unpassable sector. An unpassable sector is a sector in which trains cannot pass through.

In the example of FIG. 3, the switching unit 10 has switched the control unit assigned to each of sectors A3 to A5 from normal condition control units 21 to abnormal condition control units 22. The abnormal condition control units 22 cause the trains to perform a turn-around operation at each of sectors A3 and A5, which are turn-around operation-enabled sectors before the unpassable sector A4. A turn-around operation-enabled sector is a sector in which a train is capable of performing a turn-around operation.

The sectors A3 and A5, which are turn-around operation-enabled sectors, correspond to examples of the sections of the control subject 30 that are sections having the function of reducing the spread of the effect of the abnormality.

As a result of trains that have proceeded into sector A3 from the sector A2 side turning around in sector A3 toward the sector A2 side, it is expected that it will be possible to perform normal condition operation (operation based on the normal operation schedule) in each sector from sector A2 toward the sector A1 side, and avoid trains becoming stuck at the abnormality occurrence location.

Similarly, as a result of trains that have proceeded into sector A5 from the sector A6 side turning around in sector A5 toward the sector A6 side, it is expected that it will be possible to perform normal condition operation in each sector from sector A6 toward the sector A7 side, and avoid trains becoming stuck at the abnormality occurrence location.

Among the sections of the control subject 30, when the section that includes the abnormality occurrence location also corresponds to a section having the function of reducing the spread of the effect of the abnormality, the switching unit 10 may set only one section as the section near the abnormality occurrence location. In the example of FIG. 3, if the set of sectors A3 to A5 is a single section of the control subject 30, then at the time an abnormality occurs in sector A4, the switching unit 10 may set the section having the set of sectors A3 to A5 as the section near the abnormality occurrence location.

The setting method by which the switching unit 10 sets the sections among the sections of the control subject 30 near the abnormality occurrence location may be obtained through learning.

Alternatively, the setting method by which the switching unit 10 sets the sections among the sections of the control subject 30 near the abnormality occurrence location may be set in advance by a person. For example, the designer of the control system 1 may set in advance, on a rule basis, the setting method by which the switching unit 10 sets the sections among the sections of the control subject 30 near the abnormality occurrence location.

For example, for sector A5 in FIG. 3, the switching unit 10 may set sector A5 as one of the sections near the abnormality occurrence location when any one of sectors A4 to A7 becomes an unpassable sector.

In this way, the switching unit 10 may switch control of a single section of the control subject 30 between normal condition control and non-normal condition control based on the state of at least one section among the sections of the control subject 30.

When distinguishing between the abnormal condition control units 22 that have been assigned to sectors A3, A4 and A5, the abnormal condition control unit 22 that has been assigned to the sector Ai (where i is an integer such that 3≤i≤5) is denoted as the abnormal condition control unit 21-i.

The abnormal condition control performed by the abnormal condition control units 22 may include, in addition to or instead of a turn-around operation of the train, transfer of the train to a depot, a retreat station, or a retreat line, or retreating of the train. Further, the abnormal condition control performed by the abnormal condition control units 22 may also include operating the out-of-service train or the retreated train.

The recovery control performed by the recovery control units 23 may also include the transfer or retreating of the train, and operating the out-of-service train or the retreated train. As a result of such a control, the recovery control units 23 are capable of adjusting the number of the trains and adjusting the time.

A transferred train or retreated train from the abnormal condition control performed by the abnormal condition control units 22 may be operated according to recovery control by the recovery control units 23.

FIG. 4 is a diagram showing an example of an assignment of control units to the sections of the control subject 30 when an abnormality has been resolved in the control subject 30. FIG. 4 shows an example of a case where the abnormality that occurred in sector A4 has been resolved. In the example of FIG. 4, sector A4 is open as a result of resolving the abnormality. That is to say, a train is capable of passing through sector A4.

In the example of FIG. 4, the switching unit 10 has switched the control units assigned to each of sectors A3 to A5 from abnormal condition control units 22 to recovery control units 23. It is conceivable that, due to a turn-around operation of a train at the time an abnormality occurs, the operation status of the train has deviated from the operation status shown in the normal operation schedule. The recovery control units 23 control the sections of the control subject 30 such that the trains operate according to the normal operation schedule.

When distinguishing between the recovery control units 23 that have been assigned to sectors A3, A4 and A5, the recovery control unit 23 that has been assigned to the sector Ai (where i is an integer satisfying 3≤i≤5) is denoted as the recovery control unit 23-i.

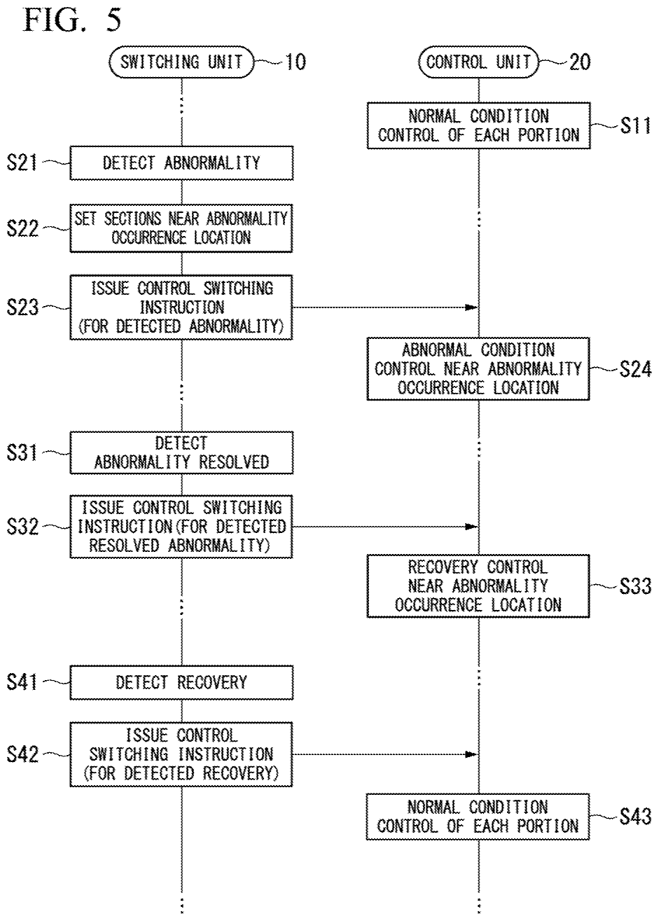

FIG. 5 is a diagram showing an example of the processing procedure performed by the control system 1.

At the start of the processing of FIG. 5, the state of the control subject 30 is the normal state, and the switching unit 10 has assigned normal condition control units 21 to each section of the control subject 30. As a result, the control unit 20 performs control of each section of the control subject 30 according to normal condition control (step S11).

Then, the switching unit 10 detects the occurrence of an abnormality in the control subject 30 (step S21). The switching unit 10 specifies the abnormality occurrence location in the control subject 30, and sets, among the sections of the control subject 30, the sections near the abnormality occurrence location (step S22).

Then, the switching unit 10 instructs the control unit 20 to perform a control switch for a detected abnormality (step S23). In the control switch instruction for a detected abnormality, the switching unit 10 instructs the control unit 20 to switch the control units assigned to the sections among the sections of the control subject 30 that have been set as sections near the abnormality occurrence location from normal condition control units 21 to abnormal condition control units 22.

The control unit 20 switches the control units assigned to the sections near the abnormality occurrence location from normal condition control units 21 to abnormal condition control units 22 according to the instruction from the switching unit 10. As a result, the control unit 20 performs control of the sections near the abnormality occurrence location according to abnormal condition control (step S24).

Then, the switching unit 10 detects that the abnormality in the control subject 30 has been resolved (step S31). The switching unit 10 instructs the control unit 20 to perform a control switch for a resolved abnormality (step S32). In the control switch instruction for a resolved abnormality, the switching unit 10 instructs the control unit 20 to switch the control units assigned to the sections among the sections of the control subject 30 that have been set as sections near the abnormality occurrence location, from abnormal condition control units 22 to recovery control units 23.

The control unit 20 switches the control units assigned to the sections near the abnormality occurrence location, from abnormal condition control units 22 to recovery control units 23 according to the instruction from the switching unit 10. As a result, the control unit 20 performs control of the sections near the abnormality occurrence location according to recovery control (step S33).

Then, the switching unit 10 detects that the state of the control subject 30 has recovered to the normal state (step S41). The switching unit 10 instructs the control unit 20 to perform a control switch for a detected recovery (step S42). In the control switch instruction for a detected recovery, the switching unit 10 instructs the control unit 20 to switch the control units assigned to the sections among the sections of the control subject 30 that have been set as sections near the abnormality occurrence location, from recovery control units 23 to normal condition control units 21.

The control unit 20 switches the control units assigned to the sections near the abnormality occurrence location, from recovery control units 23 to normal condition control units 21 according to the instruction from the switching unit 10. As a result, the control unit 20 performs control of each section of the control subject 30 according to normal condition control (step S43).

As described above, the switching unit 10 performs switching, for the sections of the control subject 30, between normal condition control and non-normal condition control of the sections based on the state of at least one section among the sections of the control subject. The control unit 20 performs control of the sections of the control subject 30 according to the switching of control by the switching unit 10.

In this way, as a result of the control unit 20 sectionally switching control of the control subject 30 according to the occurrence of an abnormality in the control subject 30, the sections among the sections of the control subject 30 in which control has not been switched are under normal condition control, and control is performed such that the state of such sections becomes the target normal state.

As a result, in the control system 1, it is expected that a difference between the state of the control subject 30 after switching control in response to the occurrence of an abnormality in the control subject 30, and the state of the control subject 30 under normal conditions will be relatively small.

As a result of the difference being small, it is expected that the state of the control subject 30 will recover to the normal state relatively quickly after the abnormality is resolved. Furthermore, as a result of the difference being small, the work of the staff handling the control subject 30 will be close to the work under normal conditions. In this respect, it is expected that the work burden on the staff handling the control subject 30 will be small.

Here, a case is considered in which control of the entire control subject is performed by a single control unit obtained by reinforcement learning. When an abnormality occurs in the control subject, the single control unit performs control of the entire control subject, which may cause locations other than the abnormality occurrence location to perform operations that are different from an operation under normal conditions.

In contrast, in the control system 1, as a result of the switching unit 10 sectionally switching control at the time an abnormality occurs, it is expected that normal condition operation will be maintained, or an operation close to normal condition operation will be performed in the sections of the control subject 30 other than those near the abnormality occurrence location. In this way, in the control system 1, it is relatively easy to predict the control with respect to the control subject 30.

Furthermore, according to the control system 1, it is expected that the spread of the influence of a local abnormality in the control subject 30 to the entire control subject 30 can be avoided. For example, when the control subject 30 is an air traffic control system, and an abnormality has occurred in a single aircraft, which corresponds to a section of the control subject 30, it is expected that the control system 1 will control the flight of each aircraft such that the abnormality of the aircraft does not affect the operation of the other aircraft as much as possible.

In the case of a control subject 30 such as a railway, where a local abnormality is considered to be an abnormality that may occur, it is assumed that the control system 1 applies non-normal condition control to only some of the sections of the control subject 30, and normal condition control is applied to the other sections. In this case, according to the control system 1, it is possible to apply non-normal condition control to only some of the sections of the control subject 30, and apply normal condition control to the other sections, without the need to provide a mechanism for limiting the application target of non-normal condition control to some of the sections among the plurality of sections of the control subject 30.

Furthermore, the switching unit 10 determines that, when an abnormality has occurred in a portion of the control subject 30, control of one or more sections among the sections of the control subject 30, including a section having a function that reduces a spread of an effect of the abnormality, is to be set to non-normal condition control.

As a result, it is expected that the abnormal condition control unit 22 will be capable of performing control of the sections of the control subject 30 such that, in the non-normal condition control, functions are executed that reduce the spread of the effect of the abnormality, and the effect of the abnormality can be limited.

Furthermore, the switching unit 10, as the non-normal condition control, switches between abnormal condition control that performs control so as to respond to an abnormality that has occurred in a portion of the control subject 30, and recovery control that performs control such that the state of the sections of the control subject 30 recover to a state under normal conditions. The control unit 20 further performs control of the sections of the control subject 30 according to a switching of the non-normal condition control by the switching unit 10. According to the control system 1, it is expected that the state of the control subject 30 will recover to the normal state relatively quickly, at the time the abnormality is resolved in the control subject 30.

Furthermore, the control unit 20, in the non-normal condition control, performs control of the sections of the control subject, according to a control method obtained by learning using an evaluation function, in which an evaluation increases as the state of the control subject approaches a state that has been set as a target state of the control subject under normal conditions.

According to the control system 1, it is expected that the state of the sections of the control subject 30 that are controlled according to abnormal condition control will be relatively close to the normal state. Therefore, it is expected that the state of each portion of the control subject 30 (both the sections controlled according to normal condition control and the sections controlled according to abnormal condition control), will be relatively close to the normal state.

As a result of the state of each portion of the control subject 30 being relatively close to the normal state, it is expected that the state of the control subject 30 will recover to the normal state relatively quickly after the abnormality is resolved. Furthermore, as a result of the state of each portion of the control subject 30 being relatively close to the normal state, the work of the staff handling the control subject 30 will be close to the work under normal conditions. In this respect, it is expected that the work burden on the staff handling the control subject 30 will be small.

Furthermore, the control unit 20, in the non-normal condition control, uses a control method obtained by learning using the evaluation function, in which an evaluation increases as the state of the control subject 30 approaches a state that has been set at each time as a target state of the control subject 30 under normal conditions.

According to the control system 1, in accordance with a case where the target state of the control subject 30 under normal conditions is dynamically set, it is known that the state of each portion of the control subject 30 is relatively close to the normal state.

In the example embodiment, an example will be described in which an evaluation function is used in the learning of the control performed by the control unit 20 or each portion thereof. However, in addition to an evaluation function, various types of functions that can evaluate provisional learning results can be used in the learning. For example, instead of an evaluation function, information representing the evaluation values of the provisional learning results in a table format may be used. An evaluation function and information representing an evaluation of the provisional learning results, such as information in a table format, are also referred to as an evaluation model.

In addition, the control subject 30 is a transportation system, and the control unit 20, in the non-normal condition control, uses a control method obtained by learning using the evaluation function, in which an evaluation increases as an operation status of a mobile body of the transportation system approaches an operation status represented by a normal operation schedule of the transportation system.

According to the control system 1, it is expected that the operation of the transportation system will be an operation that is relatively close to the operation status represented by the normal operation schedule.

As a result of the operation status of the transportation system being relatively close to the operation status represented by the normal operation schedule, it is expected that the transportation system operation status will become the operation status represented by the normal operation schedule relatively quickly after the abnormality is resolved. Furthermore, as a result of the operation status of the transportation system being relatively close to the operation status represented by the normal operation schedule, the work of the staff of the transportation system will be close to the work under normal conditions. In this respect, it is expected that the work burden on the staff handling the control subject 30 will be small.

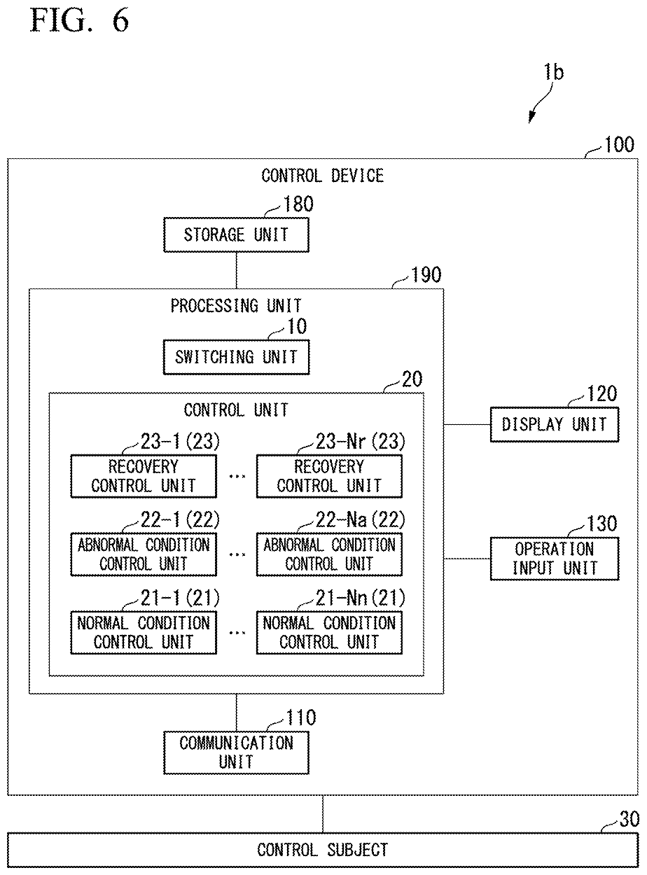

FIG. 6 is a diagram showing a second configuration example of a control system according to an example embodiment. In the configuration shown in FIG. 6, the control system 1b includes a control device 100. The control device 100 includes a communication unit 110, a display unit 120, an operation input unit 130, a storage unit 180, and a processing unit 190. The processing unit 190 includes a switching unit 10 and a control unit 20. The control unit 20 includes a plurality of normal condition control units 21, one or more abnormal condition control units 22, and one or more recovery control units 23. Furthermore, a control subject 30 is shown in FIG. 6.

Among the units in FIG. 6, the sections having the same functions as the units shown in FIG. 1 are designated by the same reference symbols (10, 20, 21, 22, 23, and 30), and a detailed description will be omitted here.

The control system 1b corresponds to an example of the control system 1. In the control system 1b, control of the control subject 30 is performed by a single control device 100.

The control device 100 performs control of the control subject 30 by executing the functions of the switching unit 10 and the control unit 20. The control device 100 is configured, for example, using a computer such as a workstation. Alternatively, the control device 100 may be configured using dedicated hardware for the control device 100, and may be configured using an ASIC (Application Specific Integrated Circuit), an FPGA (Field Programmable Gate Array), or the like.

The communication unit 110 performs communication with other devices. For example, the communication unit 110 may transmit a control command to the control subject 30. Furthermore, the communication unit 110 may receive state information such as a sensor measurement value from the control subject 30.

The display unit 120 includes, for example, a display screen such as a liquid crystal panel or an LED (Light Emitting Diode) panel, and displays various images. For example, the display unit 120 may display state information of the control subject 30, and may display information relating to the control subject 30, such as the operation schedule if the control subject 30 is a railway.

The operation input unit 130 includes input devices such as a keyboard and a mouse, and receives user operations. For example, the operation input unit 130 may receive user operations that instruct the display of information relating to the control subject 30.

The storage unit 180 stores various data. The storage unit 180 is configured by using a storage device included in the control device 100.

The processing unit 190 performs various processing that controls each unit of the control device 100. The functions of the control unit 190 are executed, for example, as a result of a CPU (Central Processing Unit) included in the control device 100 reading and executing a program from the storage unit 180.

As a result of executing control of the control subject 30 with a single device as in the control system 1b, it is expected that the maintenance load of the device will be relatively low in the respect that the number of devices is one.

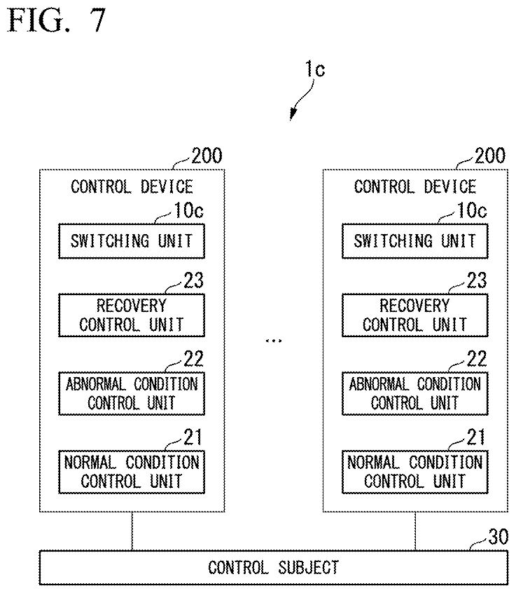

FIG. 7 is a diagram showing a third configuration example of a control system according to an example embodiment. In the configuration shown in FIG. 7, the control system 1c includes a plurality of control devices 200. The control devices 200 include a switching unit 10c, a normal condition control unit 21, an abnormal condition control unit 22, and a recovery control unit 23. Furthermore, a control subject 30 is shown in FIG. 7.

Among the units in FIG. 7, the sections units having the same functions as the units shown in FIG. 1 are designated by the same reference symbols (21, 22, 23, and 30), and a detailed description will be omitted here.

The control system 1c corresponds to an example of the control system 1.

In contrast to the control system 1b shown in FIG. 6, in which a single control device 100 centrally controls each section of the control subject 30, in the control system 1c, the control devices 200 and the sections of the control subject 30 are associated one-to-one, such that a single control device 200 performs control of a single section of the control subject 30. In all other respects, the control system 1c is the same as the control system 1b, and the control device 200 is the same as the control device 100.

The control device 200 performs control of the control subject 30 by executing the functions of the switching unit 10 and the control unit 20. The control device 100 is configured, for example, using a computer such as a workstation. Alternatively, the control device 100 may be configured using dedicated hardware for the control device 100, and may be configured using an ASIC (Application Specific Integrated Circuit), an FPGA (Field Programmable Gate Array), or the like.

The individual switching units 10c select either the normal condition control unit 21, the abnormal condition control unit 22, or the recovery control unit 23, depending on the state of the control subject 30.

The combination of the switching units 10c of all of the control devices 200 included in the control system 1c corresponds to an example of the switching unit 10 (FIG. 1), and an example of the switching means. The combination of the switching units 10c of all of the control devices 200 included in the control system 1c, at the time an abnormality occurs in the control subject 30, switches the control units assigned to the sections among the sections of the control subject 30 that have been determined as being near the abnormality occurrence location, from normal condition control units 21 to abnormal condition control units 22.

The normal condition control units 21, the abnormal condition control units 22, and the recovery control units 23 of all of the control devices 200 included in the control system 1 correspond to an example of the control unit 20 (FIG. 2), and an example of the control means. The combination of the normal condition control units 21, the abnormal condition control units 22, and the recovery control units 23 of all of the control devices 200 included in the control system 1c performs control of the control subject 30 according to the switching by the switching means.

As a result of executing control of the control subject 30 as a distributed control performed by a plurality of devices as in the control system 1c, the distance between the sections of the control subject 30 and the control devices 200 that control the sections is relatively short, and it is expected that the effect of communication delays and the like will be small.

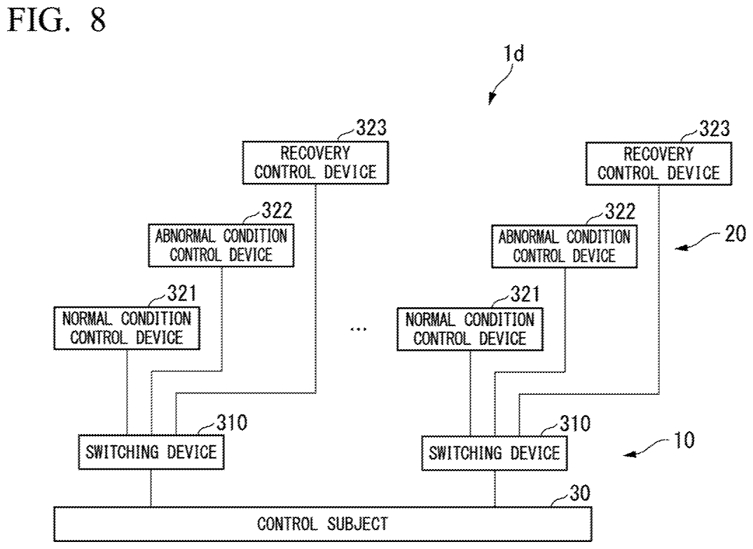

FIG. 8 is a diagram showing a fourth configuration example of a control system according to an example embodiment. In the configuration shown in FIG. 8, the control system Id includes a plurality of switching devices 310, normal condition control devices 321, abnormal condition control devices 322, and recovery control devices 323. Furthermore, a control subject 30 is shown in FIG. 8.

The control subject 30 in FIG. 8 is the same as that in FIG. 1, and a detailed description will be omitted here. In the configuration of FIG. 8, each unit of the control device in FIG. 7 is configured as a device. Specifically, in the configuration of FIG. 8, the switching unit 10c, the normal condition control unit 21, the abnormal condition control unit 22, and the recovery control unit 23 of a control device 200 in FIG. 7 are respectively configured as a switching device 310, a normal condition control device 321, an abnormal condition control device 322, and a recovery control device 323.

FIG. 8 is the same as the case of FIG. 7, except that a control device 200 in FIG. 7 is configured as a switching device 310, a normal condition control device 321, an abnormal condition control device 322, and a recovery control device 323. The normal condition control devices 321, the abnormal condition control devices 322, and the recovery control devices 323 are switched by selections made by the switching devices 310, and control the control subject 30 in a distributed manner.

All of the normal condition control devices 321, the abnormal condition control devices 322, and the recovery control devices 323 included in the control system 1d correspond to an example of the control unit 20 in FIG. 1. The combination of all of the switching devices 310 included in the control system Id corresponds to an example of the switching unit 10 in FIG. 1.

As a result of executing control of the control subject 30 as a distributed control performed by a plurality of devices as in the control system 1d, the distance between the sections of the control subject 30 and the devices that control the sections is relatively short, and it is expected that the effect of communication delays and the like will be small.

Furthermore, as a result of the normal condition control devices 321, the abnormal condition control devices 322, and the recovery control devices 323 each being configured as a device, it is possible to perform partial maintenance, replacement, and version upgrades relatively easily.

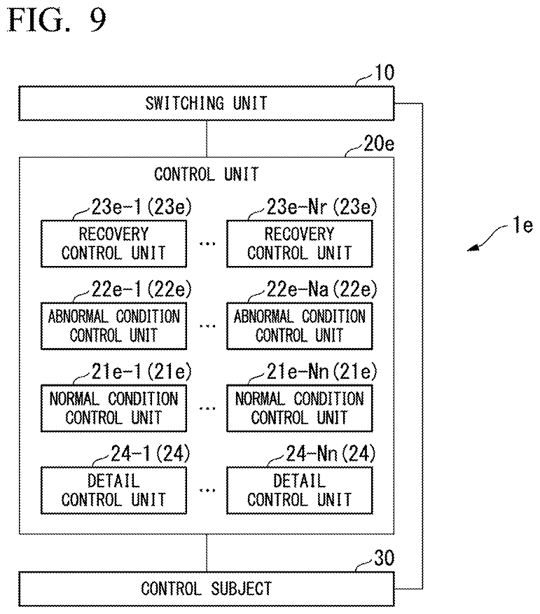

FIG. 9 is a diagram showing a fifth configuration example of a control system according to an example embodiment. In the configuration shown in FIG. 9, the control system 1 includes a switching unit 10 and a control unit 20e. The control unit 20e includes normal condition control units 21e, abnormal condition control units 22e, recovery control units 23e, and detail control units 24. Furthermore, a control subject 30 is shown in FIG. 9.

Among the units in FIG. 9, the sections having the same functions as the units shown in FIG. 1 are designated by the same reference symbols (10 and 30), and a detailed description will be omitted here.

The control unit 20e performs the processing performed by the control unit 20 (FIG. 1) in a two-stage processing using the detail control units 24. Specifically, the combination of the normal condition control units 21e and the detail control units 24 of the control unit 20e corresponds to the normal condition control units 21 of the control unit 20. The combination of the abnormal condition control units 22e and the detail control units 24 of the control unit 20e corresponds to the abnormal condition control units 22 of the control unit 20. The combination of the recovery control units 23e and the detail control units 24 of the control unit 20e corresponds to the recovery control units 23 of the control unit 20.

In all other respects, the control system 1e is the same as the control system 1. The normal condition control units 21e, the abnormal condition control units 22e, and the recovery control units 23e are the same as the normal condition control units 21, the abnormal condition control units 22, and the recovery control units 23, except that control of the sections of the control subject 30 is performed by a two-stage processing using the detail control units 24.

The detail control units 24 generate specific control commands for the sections of the control subject 30 according to the output of the normal condition control units 21e, the abnormal condition control units 22e, or the recovery control units 23e, and output the control commands to the sections of the control subject 30.

For example, when the control subject 30 is a railway, the normal condition control units 21e may output a command that indicates the presence or absence of a turn-around operation of a train as one of the control commands. Then, depending on the presence or absence of a turn-around operation of a train, the detail control units 24 may output specific commands to the facilities included in the sections of the control subject 30, such as commands for switch points and traffic signals.

In this way, as a result of the control unit 20e generating control commands for the sections of the control subject 30 in two stages, the values that can be taken by the outputs of each of the normal condition control units 21e, the abnormal condition control units 22e, and the recovery control units 23e are limited. As a result, it is expected that, when learning the processing performed by each of the normal condition control units 21e, the abnormal condition control units 22e, and the recovery control units 23e, the learning will be performed relatively easily and with a relatively high accuracy.

The detail control units 24 may, for example, be constructed on a rule basis by the designer of the control system 1e, and may be excluded from the learning.

In a similar manner to the normal condition control units 21, the control unit 20 may include the same number of detail control units 24 as sections of the control subject 30, and the sections of the control subject 30 and the detail control units 24 that control the sections may be associated one-to-one. When distinguishing between the individual detail control units 24, they are denoted as a detail control unit 24-1, a detail control unit 24-2, . . . , and a detail control unit 24-Nn. Here, Nn is a positive integer that represents the number of detail control units 24. The number of detail control units 24 is the same as the number of normal condition control units 21e.

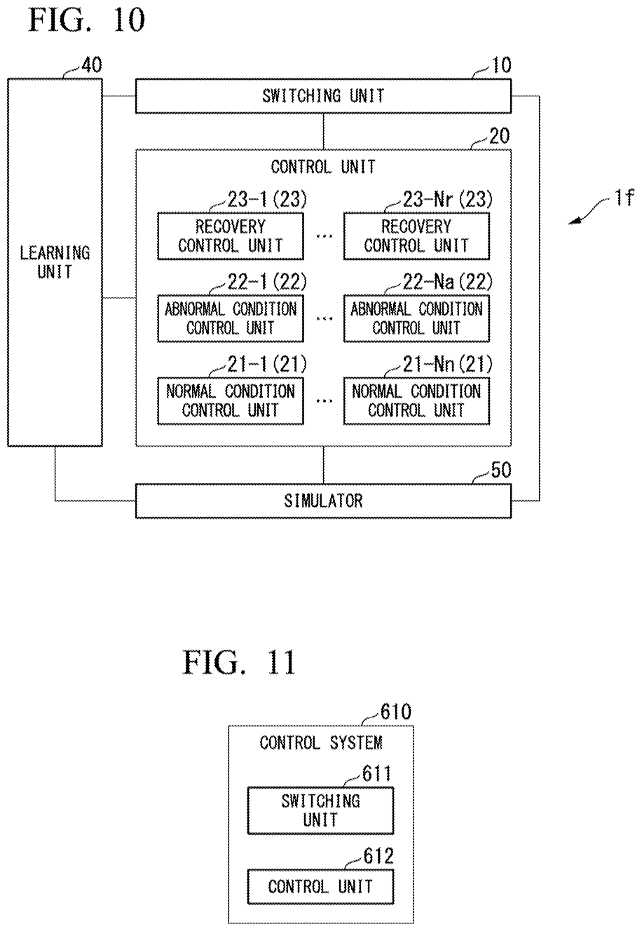

FIG. 10 is a diagram showing a sixth configuration example of a control system according to an example embodiment. FIG. 10 shows a configuration example in a learning phase of the control system 1 shown in FIG. 1.

In the configuration shown in FIG. 10, the control system 1f includes a switching unit 10, a control unit 20, and a learning unit 40. The control unit 20 includes normal condition control units 21, abnormal condition control units 22, and recovery control units 23. Furthermore, a simulator 50 is shown in FIG. 10.

The simulator 50 simulates the operation of the control subject 30. The control system If acquires training data using the simulator 50. Alternatively, in the configuration of FIG. 10, the control subject 30 may be connected to the control system 1f in addition to or instead of the simulator 50, and the control system 1f may acquire training data using the control subject 30.

The learning unit 40 performs the learning of the switching unit 10, the normal condition control units 21, the abnormal condition control units 22, and the recovery control units 23, or a portion thereof. The learning referred to here is the setting or updating of the parameter values of a learning model. The learning unit 40 updates the parameter values of the learning models of each of the switching unit 10, the normal condition control units 21, the abnormal condition control units 22, and the recovery control units 23, or updates some of the parameter values of the learning models. The learning unit 40 corresponds to an example of a learning means.

The learning unit 40 may perform the learning of the switching unit 10, the normal condition control units 21, the abnormal condition control units 22, and the recovery control units 23, or a portion thereof, by reinforcement learning.

In the control unit 20, as a result of the normal condition control units 21 and the abnormal condition control units 22 being separately configured, the learning unit 40 separately performs learning of the normal condition control performed by the normal condition control units 21 and learning of the non-normal condition control performed by the abnormal condition control units 22.

As a result, when the learning unit 40 performs learning of the normal condition control units 21 and learning of the abnormal condition control units 22 by reinforcement learning, it is expected that it will be possible to avoid the learning proceeding with a significant change in the state of the control subject 30 between normal conditions and non-normal conditions.

The learning unit 40 may acquire learning data based on an execution result of a simulation in which an occurrence time period of an abnormality and an occurrence location of an abnormality have been randomly set to the simulator 50, and then perform learning of the switching unit 10, the normal condition control units 21, the abnormal condition control units 22, and the recovery control units 23, or a portion thereof.

As a result, the learning unit 40 is capable of performing the learning of the switching unit 10, the normal condition control units 21, the abnormal condition control units 22, and the recovery control units 23 for a variety of cases in which an abnormality occurs. As a result, it is expected that the control system 1 is capable of appropriately performing control of the control subject 30 in response to various abnormalities during operation of the control system 1.

As described above, the learning unit 40 separately performs learning of each of the normal condition control performed by the normal condition control units 21 and the non-normal condition control performed by the abnormal condition control units 22 by reinforcement learning.

According to the control system If, in this respect, it is expected that it will be possible to avoid the learning proceeding with a significant change in the state of the control subject 30 between normal conditions and non-normal conditions.

Furthermore, the learning unit 40 performs learning of normal condition control performed by the normal condition control units 21 and learning of non-normal condition control performed by the abnormal condition control unit 22 using an execution result of a simulation in which an occurrence time period of an abnormality and an occurrence location of an abnormality have been randomly set to the simulator 50.

According to the control system 1f, the learning unit 40 is capable of performing learning of the switching unit 10, the normal condition control units 21, the abnormal condition control units 22, and the recovery control units 23 for a variety of cases in which an abnormality occurs.

As a result, it is expected that the control system 1 is capable of appropriately performing control of the control subject 30 in response to various abnormalities during operation of the control system 1.

FIG. 11 is a diagram showing a seventh configuration example of a control system according to an example embodiment. In the configuration shown in FIG. 11, the control system 610 includes a switching unit 611 and a control unit 612.

In this configuration, the switching unit 611 switches the sections of the control subject between normal condition control and non-normal condition control of the sections, based on the state of at least one section among the sections of the control subject. The control unit 612 performs control of the sections of the control subject according to switching of the control by the The switching unit 611 corresponds to an example of a switching means. The control unit 612 corresponds to an example of a control means.

switching unit 611.

In this way, as a result of the control unit 612 sectionally switching control of the control subject according to the occurrence of an abnormality in the control subject, the sections among the sections of the control subject in which control has not been switched are under normal condition control, and control is performed such that the state of such sections becomes the target normal state.

As a result, in the control system 610, it is expected that a difference between the state of the control subject after switching control in response to the occurrence of an abnormality in the control subject, and the state of the control subject under normal conditions will be relatively small.

As a result of the difference being small, it is expected that the state of the control subject will recover to the normal state relatively quickly after the abnormality is resolved. Furthermore, as a result of the difference being small, the work of the staff handling the control subject will be close to the work under normal conditions. In this respect, it is expected that the work burden on the staff handling the control subject will be small.

Here, a case is considered in which control of the entire control subject is performed by a single control unit obtained by reinforcement learning. When an abnormality occurs in the control subject, the single control unit performs control of the entire control subject, which may cause locations other than the abnormality occurrence location to perform operations that are different from an operation under normal conditions.

In contrast, in the control system 610, as a result of the switching unit 611 sectionally switching control at the time an abnormality occurs, it is expected that normal condition operation will be maintained, or an operation close to normal condition operation will be performed in the sections of the control subject other than those near the abnormality occurrence location. In this way, in the control system 610, it is relatively easy to predict the control with respect to the control subject.

Furthermore, according to the control system 610, it is expected that the spread of the influence of a local abnormality in the control subject to the entire control subject can be avoided.

The switching unit 611 can be realized, for example, using the functions of the switching unit 10 and the like shown in FIG. 1. The control unit 612 can be implemented using the functions of the control unit 20 and the like in FIG. 1.

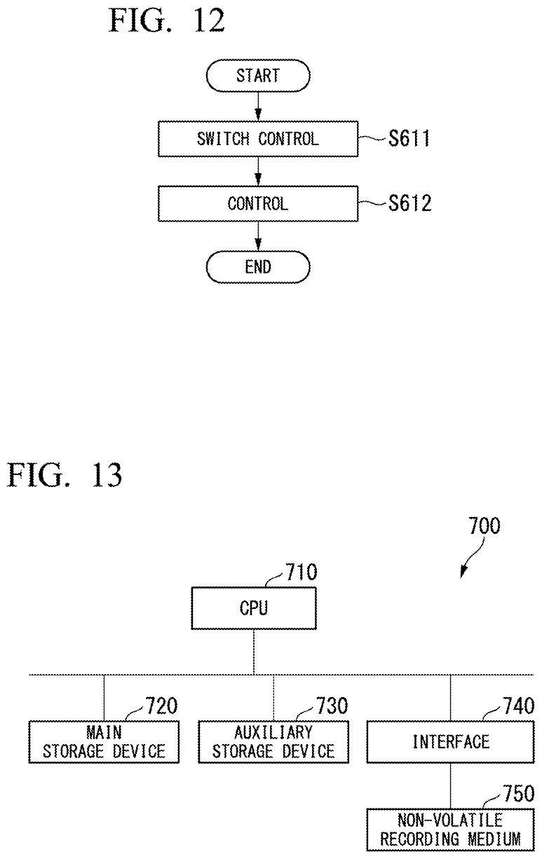

FIG. 12 is a diagram showing an example of the processing procedure of a control method according to an example embodiment.

The control method shown in FIG. 12 includes switching control (step S611), and performing control (step S612).

In the step of switching control (step S611), a computer switches, for the sections of the control subject, between normal condition control and non-normal condition control of the sections, such switching being performed based on the state of at least one section among the sections of the control subject. In the step of performing control (step S612), a computer performs control of the sections of the control subject according to a switching of the control.

In this way, as a result of sectionally switching control of the control subject according to the occurrence of an abnormality in the control subject, the sections among the sections of the control subject in which control has not been switched are under normal condition control, and control is performed such that the state of such sections becomes the target normal state.

As a result, in the control method shown in FIG. 12, it is expected that a difference between the state of the control subject after switching control in response to the occurrence of an abnormality in the control subject, and the state of the control subject under normal conditions will be relatively small.

As a result of the difference being small, it is expected that the state of the control subject will recover to the normal state relatively quickly after the abnormality is resolved. Furthermore, as a result of the difference being small, the work of the staff handling the control subject will be close to the work under normal conditions. In this respect, it is expected that the work burden on the staff handling the control subject will be small.

Here, a case is considered in which control of the entire control subject is performed by a single control unit obtained by reinforcement learning. When an abnormality occurs in the control subject, the single control unit performs control of the entire control subject, which may cause locations other than the abnormality occurrence location to perform operations that are different from an operation under normal conditions.

In contrast, in the control method shown in FIG. 12, as a result of sectionally switching the control at the time an abnormality occurs, it is expected that normal condition operation will be maintained, or operation close to normal condition operation will be performed in the sections of the control subject other than those near the abnormality occurrence location. In this way, in the control method shown in FIG. 12, it is relatively easy to predict the control with respect to the control subject.

Furthermore, according to the control method shown in FIG. 12, it is expected that the spread of the influence of a local abnormality in the control subject to the entire control subject can be avoided.

FIG. 13 is a schematic block diagram showing a configuration of a computer according to at least one example embodiment.

In the configuration shown in FIG. 13, a computer 700 includes a CPU 710, a main storage device 720, an auxiliary storage device 730, an interface 740, and a non-volatile recording medium 750.

Any one or more of the control system 1, the control device 100, the control device 200, the switching device 310, the normal condition control device 321, the abnormal condition control device 322, the recovery control device 323, the control system 1e, and the control system If, or a portion thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Furthermore, the CPU 710 reserves a storage area corresponding to each of the storage units in the main storage device 720 according to the program. The communication of each device with other devices is executed as a result of the interface 740 having a communication function and performing communication according to the control of the CPU 710.

When the control system 1 is implemented by the computer 700, the operation of the switching unit 10, the control unit 20, and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the control system 1 in the main storage device 720 according to the program. The communication between the control system 1 and other devices is executed as a result of the interface 740 including a communication function and operating under the control of the CPU 710. The interactions between the control system 1 and the user are executed as a result of the interface 740 having a display device and an input device, various images being displayed according to control by the CPU 710, and receiving a user input.

When the control device 100 is implemented by the computer 700, the operation of the processing unit 190 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the storage unit 180 in the main storage device 720 according to the program. The communication by the communication unit 110 with other devices is executed as a result of the interface 740 including a communication function and operating under the control of the CPU 710. The display of images by the display unit 120 is executed as a result of the interface 740 including a display device, and displaying various images under the control of the CPU 710. The reception of user operations by the operation input unit 130 is executed as a result of the interface 740 including an input device, and receiving user operations under the control of the CPU 710.

When the control device 200 is implemented by the computer 700, the operation of the switching unit 10c, the normal condition control unit 21, the abnormal condition control unit 22, and the recovery control unit 23 is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the control device 200 in the main storage device 720 according to the program. The communication between the control device 200 and other devices is executed as a result of the interface 740 including a communication function and operating under the control of the CPU 710. The interactions between the control device 200 and the user are executed as a result of the interface 740 having a display device and an input device, various images being displayed according to control by the CPU 710, and receiving a user input.

When the switching device 310 is implemented by the computer 700, the operation thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the switching device 310 in the main storage device 720 according to the program. The communication between the switching device 310 and other devices is executed as a result of the interface 740 including a communication function and operating under the control of the CPU 710. The interactions between the switching device 310 and the user are executed as a result of the interface 740 having a display device and an input device, various images being displayed according to control by the CPU 710, and receiving a user input.

When the normal condition control device 321 is implemented by the computer 700, the operation thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the normal condition control device 321 in the main storage device 720 according to the program. The communication between the normal condition control device 321 and other devices is executed as a result of the interface 740 including a communication function and operating under the control of the CPU 710. The interactions between the normal condition control device 321 and the user are executed as a result of the interface 740 having a display device and an input device, various images being displayed according to control by the CPU 710, and receiving a user input.

When the abnormal condition control device 322 is implemented by the computer 700, the operation thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the abnormal condition control device 322 in the main storage device 720 according to the program. The communication between the abnormal condition control device 322 and other devices is executed as a result of the interface 740 including a communication function and operating under the control of the CPU 710. The interactions between the abnormal condition control device 322 and the user are executed as a result of the interface 740 having a display device and an input device, various images being displayed according to control by the CPU 710, and receiving a user input.

When the recovery control device 323 is implemented by the computer 700, the operation thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the recovery control device 323 in the main storage device 720 according to the program. The communication between the recovery control device 323 and other devices is executed as a result of the interface 740 including a communication function and operating under the control of the CPU 710. The interactions between the recovery control device 323 and the user are executed as a result of the interface 740 having a display device and an input device, various images being displayed according to control by the CPU 710, and receiving a user input.

When the control system 1e is implemented by the computer 700, the operation of the switching unit 10, the control unit 20e, and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the control system 1e in the main storage device 720 according to the program. The communication between the control system 1e and other devices is executed as a result of the interface 740 including a communication function and operating under the control of the CPU 710. The interactions between the control system 1e and the user are executed as a result of the interface 740 having a display device and an input device, various images being displayed according to control by the CPU 710, and receiving a user input.

When the control system 1f is implemented by the computer 700, the operation of the switching unit 10, the control unit 20, the learning unit 40, and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 reserves a storage area for the processing of the control system 1f in the main storage device 720 according to the program. The communication between the control system 1f and other devices is executed as a result of the interface 740 including a communication function and operating under the control of the CPU 710. The interactions between the control system 1f and the user are executed as a result of the interface 740 having a display device and an input device, various images being displayed according to control by the CPU 710, and receiving a user input.

One or more of the programs described above may be recorded in the non-volatile recording medium 750. In this case, the interface 740 may read out the program from the non-volatile recording medium 750. Then, the CPU 710 directly executes the program that has been read out by the interface 740, or executes the program after temporarily saving it in the main storage device 720 or the auxiliary storage device 730.

Furthermore, a program for executing some or all of the processing performed by the control system 1, the control device 100, the control device 200, the switching device 310, the normal condition control device 321, the abnormal condition control device 322, the recovery control device 323, the control system 1e, and the control system 1f may be recorded in a computer-readable recording medium, and the processing of each unit may be performed by a computer system reading and executing the program recorded on the recording medium. The “computer system” referred to here is assumed to include an OS and hardware such as a peripheral device.

Furthermore, the “computer-readable recording medium” refers to a portable medium such as a flexible disk, a magnetic optical disk, a ROM (Read Only Memory), or a CD-ROM

(Compact Disc Read Only Memory), or a storage device such as a hard disk built into a computer system. Moreover, the program may be one capable of realizing some of the functions described above. Further, the functions described above may be realized in combination with a program already recorded in the computer system.

An example embodiment of the present disclosure has been described in detail above with reference to the drawings. However, specific configurations are in no way limited to the example embodiment, and include designs and the like within a scope not departing from the spirit of the present disclosure.

This application is based upon and claims the benefit of priority from Japanese patent application No. 2021-173888, filed Oct. 25, 2021, the disclosure of which is incorporated herein in its entirety.

### INDUSTRIAL APPLICABILITY

The present disclosure may be applied to a control system, a control method, and a recording medium.

### DESCRIPTION OF REFERENCE SYMBOLS

1, 1b, 1c, 1d, 1e, 1f, 610 Control system
10, 10c, 611 Switching unit
20, 20c, 612 Control unit
21, 21e Normal condition control unit
22, 22e Abnormal condition control unit
23, 23e Recovery control unit
24 Detail control unit
30 Control subject
40 Learning unit
50 Simulator
100, 200 Control device
110 Communication unit
120 Display unit
130 Operation input unit
180 Storage unit
190 Processing unit
310 Switching device
321 Normal condition control device
322 Abnormal condition control device
323 Recovery control device

1. A control system comprising:
a processor configured to execute the instructions; and
a memory configured to execute the instructions to:
switch control of sections of a control subject, between normal condition control and non-normal condition control of the sections, based on a state of at least one section among the sections of the control subject; and
perform the control of the sections of the control subject according to a switching of the control by the switching means.

2. The control system according to claim 1, wherein the processor is configured to execute the instructions to determine that, in a case where an abnormality has occurred in a portion of the control subject, control of one or more sections among the sections of the control subject, including a section having a function that reduces a spread of an effect of the abnormality, is set to be the non-normal condition control.

3. The control system according to claim 1,
wherein the processor is configured to execute the instructions to, as the non-normal condition control, switch between: abnormal condition control that performs control so as to respond to an abnormality that has occurred in a portion of the control subject; and recovery control that performs control such that a state of the sections of the control subject recover to a state of being under a normal condition, and
the processor is configured to execute the instructions to further perform the control of the sections of the control subject according to a switching of the non-normal condition control.

4. The control system according to claim 1, wherein the processor is configured to execute the instructions to, in the non-normal condition control, perform control of the sections of the control subject according to a control method obtained by learning using an evaluation function, in which an evaluation increases as a state of the control subject approaches a state that is set as a target state of the control subject under a normal condition.

5. The control system according to claim 4, wherein the processor is configured to execute the instructions to, in the non-normal condition control, use a control method obtained by learning using the evaluation function, in which an evaluation increases as a state of the control subject approaches a state that is set at each time as the target state of the control subject under a normal condition.

6. The control system according to claim 5,
wherein the control subject is a transportation system, and
the processor is configured to execute the instructions to, in the non-normal condition control, use a control method obtained by learning using the evaluation function, in which an evaluation increases as an operation status of a mobile body of the transportation system approaches an operation status represented by a normal operation schedule of the transportation system.

7. The control system according to claim 1, wherein the processor is configured to execute the instructions to individually perform learning of the normal condition control and learning of the non-normal condition control by reinforcement learning.

8. The control system according to claim 7, wherein the processor is configured to execute the instructions to perform learning of the normal condition control and learning of the non-normal condition control using an execution result of a simulation in which an occurrence time period of an abnormality and an occurrence location of an abnormality have been randomly set to a simulator of the control subject.

9. A control method executed by a computer, comprising:
switching control of sections of a control subject, between normal condition control and non-normal condition control of the sections, based on a state of at least one section among the sections of the control subject; and
performing the control of the sections of the control subject according to a switching of the control.

10. A non-transitory computer readable recording medium that stores a program that causes a computer to execute:
switching control of sections of a control subject, between normal condition control and non-normal condition control of the sections, based on a state of at least one section among the sections of the control subject; and
performing the control of the sections of the control subject according to a switching of the control.
